(19) United States
(12) Patent Application Publication
(10) Pub. No.: US 2026/0008455 A1
(43) Pub. Date: Jan. 8, 2026

(54) VEHICLE CONTROL METHOD AND VEHICLE CONTROL DEVICE

(71) Applicant: Panasonic Automotive Systems Co., Ltd., Kanagawa (JP)

(72) Inventors: Yuji KANEKO, Kanagawa Ken (JP); Hirofumi NISHIMURA, Kanagawa Ken (JP)

(73) Assignee: Panasonic Automotive Systems Co., Ltd., Kanagawa (JP)

(21) Appl. No.: 19/261,519

(22) Filed: Jul. 7, 2025

(30) Foreign Application Priority Data
Jul. 8, 2024 (JP) 2024-109320

(51) Int. Cl. B60W 30/09; B60K 35/28; B60W 30/095; B60W 30/14; B60W 30/16; B60W 30/182; B60W 50/14; B60W 60/00; G06V 20/58

(52) U.S. Cl. CPC B60W 30/09; B60K 35/28; B60W 30/0956; B60W 30/143; B60W 30/16; B60W 30/182; B60W 50/14; B60W 60/0015; G06V 20/58; B60K 2360/176; B60K 2360/1876; B60K 2360/191; B60W 2050/146; B60W 2420/403; B60W 2554/802

(57) ABSTRACT

A vehicle control method is implemented in a vehicle including a sensor device and a display device. The method includes decelerating the vehicle at a first deceleration when the sensor device detects an obstacle at a distance closer than a first distance from the vehicle in a traveling direction during traveling. The method includes causing the vehicle to travel at a predetermined speed from a second distance shorter than the first distance to a third distance shorter than the second distance within a distance from the vehicle to the obstacle, and causing the display device to display information representing that the vehicle is being intentionally decelerated. The method includes decelerating the vehicle at a second deceleration greater than the first deceleration when the obstacle is detected at a distance closer than a fourth distance shorter than the third distance from the vehicle in the traveling direction.

### CROSS-REFERENCE TO RELATED APPLICATIONS

This application is based upon and claims the benefit of priority from Japanese Patent Application No. 2024-109320, filed on Jul. 8, 2024, the entire contents of which are incorporated herein by reference.

### FIELD

Embodiments described herein relate generally to a vehicle control method and a vehicle control device.

### BACKGROUND

There is a known system that determines a possibility of collision against an obstacle present on a traveling road of a host vehicle based on a distance from the host vehicle and a relative speed, and automatically operates control of a brake of the host vehicle in a case where there is the possibility of collision (see, for example, Patent Literature JP 2024-7010 A).

In addition, there is a technology for suddenly stopping a vehicle by operating emergency braking.

However, in the related art, a technology related to notification at the time of performing automated deceleration for collision avoidance is not disclosed, and there is a case where it is difficult to assist suitable traveling for a passenger.

Therefore, a technical scheme to assist more suitable traveling of a vehicle is desired.

### SUMMARY

A vehicle control method according one aspect of the present disclosure is executed by a vehicle control device provided in a vehicle. The vehicle includes an operation device to receive an operation of a passenger, a sensor device to detect an outside situation, a display device to display information visually recognizable by the passenger, and a movement control device to control at least deceleration of the vehicle. The vehicle control method includes: decelerating the vehicle at a first deceleration, in a case where the sensor device detects an obstacle at a distance closer than a first distance from the vehicle in a traveling direction of the vehicle during traveling of the vehicle with an acceleration and deceleration operation and a steering operation by the passenger; causing the vehicle to travel at a predetermined speed from a second distance shorter than the first distance to a third distance shorter than the second distance within a distance from the vehicle to the obstacle, and causing the display device to display information representing that the vehicle is being intentionally decelerated; and decelerating the vehicle at a second deceleration greater than the first deceleration, in a case where the sensor device detects the obstacle at a distance closer than a fourth distance shorter than the third distance from the vehicle in the traveling direction of the vehicle.

### BRIEF DESCRIPTION OF THE DRAWINGS

FIG. 1 is a block diagram illustrating an example of an overall configuration of a vehicle;

FIG. 2 is a schematic diagram illustrating an example of arrangement of cameras;

FIG. 3 is an explanatory diagram of an example of deceleration control processing executed by a control unit;

FIG. 4 is a diagram illustrating an example of a relationship between a distance between the vehicle and an obstacle and a speed of the vehicle;

FIG. 5 is a schematic diagram of an example of a first screen;

FIG. 6A is a schematic diagram of an example of a second screen;

FIG. 6B is a schematic diagram of an example of a second screen;

FIG. 6C is a schematic diagram of an example of a second screen;

FIG. 7 is a schematic diagram of an example of a third screen;

FIG. 8 is a flowchart illustrating an example of a procedure of information processing executed by the control unit; and

FIG. 9 is a block diagram illustrating a hardware configuration example of a vehicle control device.

### DETAILED DESCRIPTION

Hereinafter, embodiments of a vehicle control method and a vehicle control device according to the present disclosure will be described with reference to the drawings.

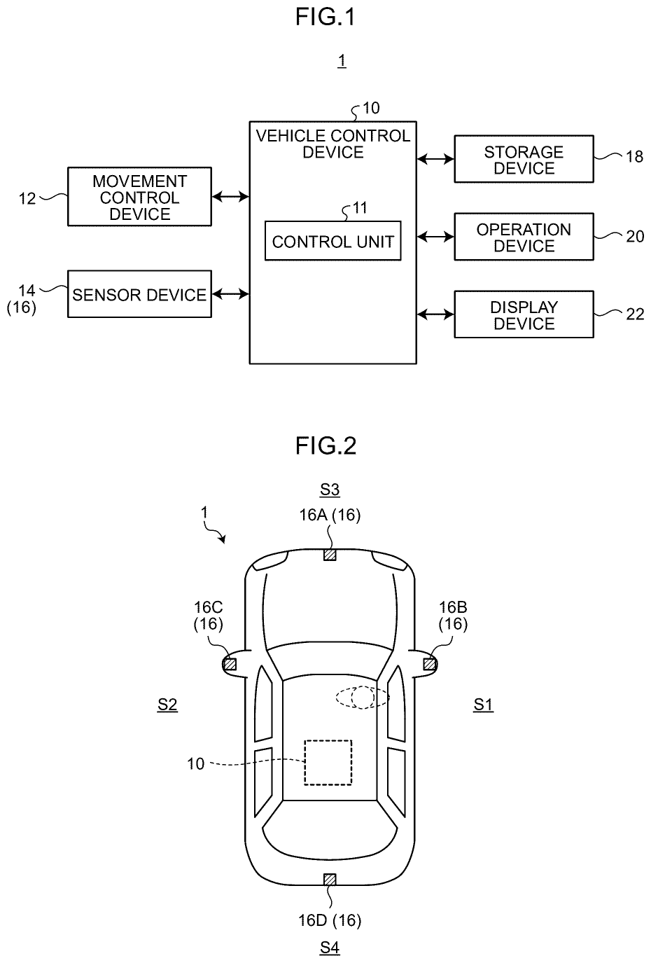

FIG. 1 is a block diagram illustrating an example of an overall configuration of a vehicle 1.

The vehicle 1 includes a vehicle control device 10, a movement control device 12, a sensor device 14, a storage device 18, an operation device 20, and a display device 22.

The movement control device 12, the sensor device 14, the storage device 18, the operation device 20, and the display device 22 are connected to the vehicle control device 10 so as to be able to exchange data or a signal. That is, the vehicle control device 10 is set to be communicably connected to at least the sensor device 14, the operation device 20, the display device 22, and the movement control device 12.

The movement control device 12 controls at least deceleration of the vehicle 1. The movement control device 12 is means for implementing driving, braking, and turning motions necessary for traveling of the vehicle 1. For example, the movement control device 12 includes a drive motor, a power transmission mechanism, a brake device, a steering device, and the like, and an electronic vehicle control device that controls the drive motor, the power transmission mechanism, the brake device, the steering device, and the like. The movement control device 12 causes the vehicle 1 to travel by, for example, generating power with the drive motor and transmitting the power to wheels via the power transmission mechanism. The power transmission mechanism is, for example, a propeller shaft, a differential gear, a drive shaft, or the like.

Controlling the deceleration means that the movement control device 12 controls at least one of the driving and braking necessary for the traveling of the vehicle 1. That is, controlling the deceleration means that the movement control device 12 controls a deceleration which is an acceleration applied during the deceleration.

The movement control device 12 also controls the acceleration and deceleration and steering of the vehicle 1.

Controlling the acceleration and deceleration means that the movement control device 12 controls at least one of the driving and braking necessary for the traveling of the vehicle 1. That is, controlling the acceleration and deceleration means that the movement control device 12 controls an acceleration applied during the acceleration and a deceleration which is an acceleration applied during the deceleration.

Controlling the steering means that the movement control device 12 controls at least one of the driving, braking, and turning motions necessary for the traveling of the vehicle 1. That is, controlling the steering means that the movement control device 12 controls at least one of a turning direction by steering, a vehicle speed or acceleration by accelerator steering, and deceleration or stop by brake steering.

The sensor device 14 is provided in the vehicle 1 to detect at least an outside situation of the vehicle 1. Specifically, the sensor device 14 includes various sensors that detect a traveling state of the vehicle 1 and the outside situation of the vehicle 1. The outside situation includes a video of an area outside the vehicle 1.

The sensor device 14 includes at least one of a camera 16, a light detection and ranging (LiDAR), a radar, a sonar, and an ultrasonic sensor. In addition, the sensor device 14 includes an accelerator pedal position sensor that detects an accelerator pedal position, a steering angle sensor that detects a steering angle of the steering device, a steering wheel rotation operation angle detection sensor that detects an angle of a steering wheel rotation operation of a steering wheel, an acceleration sensor that detects the acceleration applied during the acceleration and the deceleration of the vehicle 1, a torque sensor that detects a torque acting on the power transmission mechanism between the wheels of the vehicle 1 and the drive motor, a vehicle speed sensor that detects a vehicle speed of the vehicle 1, a wheel speed sensor, and the like.

The camera 16 is a surrounding sensor that is mounted on the vehicle 1 to monitor a surrounding environment of the vehicle 1. In other words, the camera 16 captures at least part of the surroundings of the vehicle 1 as captured video data. In the present embodiment, the camera 16 captures the surroundings of the vehicle 1 and outputs captured video data to the vehicle control device 10. Hereinafter, the captured video data may be simply referred to as a video. In the present embodiment, the camera 16 is also applied to an application of detecting an object present around the vehicle 1 and estimating a position where the vehicle 1 is present from a positional relationship between the vehicle 1 and the object present around the vehicle 1.

A position of the camera 16, the number of installed cameras, and a capturing direction of the camera are adjusted in advance such that the surroundings of the vehicle 1 can be captured.

FIG. 2 is a schematic diagram illustrating an example of arrangement of the camera 16.

The vehicle 1 is provided with, for example, four cameras 16 so as to be able to acquire the outside situation of the vehicle 1 in at least four directions of a first side S1, a second side S2, a front side S3, and a rear side S4 of the vehicle 1. The first side S1 is one side direction of the vehicle 1. The second side S2 is a side of the vehicle 1 that is opposite to the first side S1.

Specifically, for example, the camera 16 includes a first camera 16A, a second camera 16B, a third camera 16C, and a fourth camera 16D. The first camera 16A is placed at a front part of the vehicle 1 and captures an image of the front side S3 of the vehicle 1. The second camera 16B is placed at a right part of the vehicle 1 and captures an image of the first side S1 of the vehicle 1. The third camera 16C is placed at a left part of the vehicle 1 and captures an image of the second side S2 of the vehicle 1. The fourth camera 16D is placed at a rear part of the vehicle 1 and captures an image of the rear side S4 of the vehicle 1. The number of cameras 16 provided in the vehicle 1 is not limited to four. As for sensors that detect an object, such as the LiDAR, the radar, the sonar, and the ultrasonic sensor included in the sensor device 14, it is preferable that the arrangement position, the number of sensors, and the like are adjusted in advance such that the outside situation of each of the first side S1, the second side S2, the front side S3, and the rear side S4 of the vehicle 1 can be acquired.

Returning to FIG. 1, the description continues. The sensor device 14 outputs sensor information obtained by the detection to the vehicle control device 10. The sensor information includes a detection result of the sensor device 14 such as the LiDAR, the radar, the sonar, the ultrasonic sensor, the accelerator pedal position sensor, the steering angle sensor, the angle of the steering wheel rotation operation, a traveling direction of the vehicle 1, the deceleration of the vehicle 1, the torque, the vehicle speed, the video captured by the camera 16, or the like.

The storage device 18 stores various data. The storage device 18 is, for example, an auxiliary storage device such as a hard disk drive (HDD), a solid state drive (SSD), or a flash memory. At least part of the data included in the storage device 18 may be stored in an external storage device such as a server device provided outside the vehicle 1 and communicably connected to the vehicle control device 10.

The operation device 20 receives an operation by a passenger of the vehicle 1. The operation device 20 includes a steering device such as the steering wheel, an operation mechanism related to a driving operation such as an accelerator pedal, a brake pedal, a turn signal lever, and a push-button switch, and an input device such as a keyboard, a touch panel, or a switch. The operation device 20 may form part of at least one of a human machine interface (HMI) and an in-vehicle infotainment (IVI).

The display device 22 is a display that outputs various images. The display device 22 is installed at a position visually recognizable by the passenger of the vehicle 1. Examples of the display include a liquid crystal display (LCD), an organic electro-luminescence (EL) display, and a projector. The display may also be a touch panel display in which the display device 22 and the operation device 20 are integrally configured. The display device 22 is an example of the HMI.

The vehicle control device 10 is an electronic control unit (ECU) that integrally controls each unit of the vehicle 1. The vehicle control device 10 is provided in the vehicle 1.

The vehicle control device 10 controls the movement control device 12 by using the sensor information and the like received from the sensor device 14. In addition, the vehicle control device 10 controls the movement control device 12 to perform traveling according to an operation that is the driving operation of the operation device 20 by the passenger.

The vehicle control device 10 includes a control unit 11. Part of or the entire control unit 11 may have a software configuration implemented by cooperation of a processor and various programs stored in a memory. In addition, part of or the entire control unit 11 may have a hardware configuration implemented by a dedicated circuit or the like.

The control unit 11 integrally controls the respective units of the vehicle 1.

The control unit 11 is configured to be able to switch a traveling mode to a first traveling mode or a second traveling mode based on an input operation or the like of the operation device 20 by the passenger. The traveling mode executable by the vehicle 1 may include various traveling modes other than the first traveling mode and the second traveling mode.

The first traveling mode is a mode in which the control unit 11 autonomously controls at least the acceleration and deceleration and the steering to cause the vehicle 1 to perform autonomous traveling. The autonomous traveling of the vehicle 1 may be referred to as autonomous traveling. That is, the first traveling mode is a mode for causing the vehicle 1 to perform the autonomous traveling without a manual operation related to the acceleration and deceleration and the steering by the passenger.

In the first traveling mode, the vehicle 1 is automatically controlled to travel by the vehicle control device 10 without the manual operation related to the acceleration and deceleration and the steering by the passenger. That is, in the first traveling mode, the control unit 11 controls the acceleration and deceleration and the steering based on the outside situation acquired by the sensor device 14 without the manual operation related to the acceleration and deceleration and the steering by the passenger to cause the vehicle 1 to perform the autonomous traveling.

The second traveling mode is a mode in which the control unit 11 autonomously controls the deceleration without autonomously controlling at least the steering and the acceleration. That is, the second traveling mode is a mode for performing automated deceleration control for the deceleration without an operation related to the deceleration by the passenger, receiving an operation related to the steering and the acceleration by the passenger at least for the steering and the acceleration, and performing traveling control according to the operation.

In the second traveling mode, the vehicle 1 controls the movement control device 12 to perform traveling based on the manual operation related to the acceleration and the steering by the passenger, and controls the movement control device 12 to perform the deceleration based on the outside situation acquired by the sensor device 14 without the manual operation related to the deceleration by the passenger.

In the present embodiment, the control unit 11 executes the following processing when the traveling mode is the second traveling mode. The control unit 11 may also execute the following processing when the traveling mode is a mode other than the second traveling mode.

The control unit 11 specifies a distance to the obstacle detected by the sensor device 14 when the vehicle 1 performs traveling with an acceleration and deceleration operation and a steering operation of the passenger.

The acceleration and deceleration operation means an operation of at least one of an accelerator and a brake included in the operation device 20 by the passenger. The steering operation means an operation of a steering included in the operation device 20 by the passenger.

The obstacle is an obstacle for the traveling of the vehicle 1. Specifically, for example, the obstacle is another vehicle other than the vehicle 1 or an object such as a person.

The control unit 11 specifies the distance from the vehicle 1 to the obstacle in the traveling direction of the vehicle 1 based on the sensor information. Specifically, it is sufficient that the control unit 11 derives the distance from the vehicle 1 to the obstacle in the traveling direction of the vehicle 1 by analyzing the detection result of the sensor device 14 such as the LiDAR, the radar, the sonar, the ultrasonic sensor, or the video included in the sensor information by a known method.

Then, the control unit 11 executes deceleration control processing and display control processing according to the distance to the obstacle present in a traveling direction D of the vehicle 1.

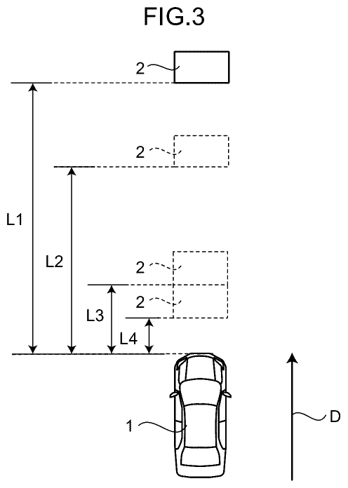

FIG. 3 is an explanatory diagram of an example of the deceleration control processing executed by the control unit 11.

In a case where the sensor device 14 detects an obstacle 2 at a distance closer than a first distance L1 from the vehicle 1 in the traveling direction D of the vehicle 1 during the traveling of the vehicle 1 with the acceleration and deceleration operation and the steering operation of the passenger, the control unit 11 decelerates the vehicle 1 at a first deceleration. The control unit 11 controls the movement control device 12 to perform the deceleration at the first deceleration. With this control, the vehicle 1 performs the deceleration at the first deceleration.

It is sufficient that the first distance L1 is a predetermined distance. It is sufficient that a distance between the vehicle 1 and the obstacle 2, which is a target for decelerating the vehicle 1 at the first deceleration, may be determined in advance as the first distance L1. In addition, the first distance L1 may be appropriately changed with an operation instruction of the operation device 20 by the passenger or the like.

The first deceleration is a deceleration lower than a second deceleration described below. The deceleration of the vehicle 1 at the first deceleration may be referred to as gentle braking since automatic braking is being operated gently.

Thereafter, the control unit 11 causes the vehicle 1 to travel at a predetermined speed from a second distance L2 to a third distance L3 as the distance from the vehicle 1 to the obstacle 2.

The second distance L2 is a distance shorter than the first distance L1. In other words, the second distance L2 is a distance smaller than the first distance L1. The third distance L3 is a distance shorter than the second distance L2. In other words, the third distance L3 is a distance smaller than the second distance L2. It is sufficient that distances satisfying the above condition are determined in advance as the second distance L2 and the third distance L3. In addition, the second distance L2 and the third distance L3 may be appropriately changeable so as to satisfy the above condition by the operation instruction of the operation device 20 by the passenger or the like. The second distance L2 and the third distance L3 are, for example, distances in a range of 2 m to 3 m, but are not limited thereto.

It is sufficient that the predetermined speed is a minimum traveling speed according to a traveling environment of the vehicle 1. The predetermined speed may be set in advance. In addition, the predetermined speed may be appropriately changed by the operation instruction of the operation device 20 by the passenger or the like. Moreover, the predetermined speed may be a speed that is appropriately adjusted by the control unit 11 so as to be a minimum speed at which safe traveling is possible in accordance with the traveling environment such as a road rule defined for the traveling road on which the vehicle 1 travels or a traffic jam situation.

Thereafter, in a case where the sensor device 14 detects the obstacle 2 at a distance closer than a fourth distance L4 in the traveling direction D of the vehicle 1, the control unit 11 decelerates the vehicle 1 at the second deceleration.

The fourth distance L4 is a distance shorter than the third distance L3. In other words, the fourth distance L4 is a distance smaller than the third distance L3. It is sufficient that a distance satisfying the above condition is determined in advance as the fourth distance L4. In addition, the fourth distance L4 may be appropriately changeable so as to satisfy the above condition by the operation instruction of the operation device 20 by the passenger or the like. The fourth distance L4 is, for example, a distance for starting operation of autonomous emergency braking (AEB) in the vehicle 1.

The second deceleration is a deceleration greater than the first deceleration. The deceleration of the vehicle 1 at the second deceleration may be referred to as emergency braking or the like.

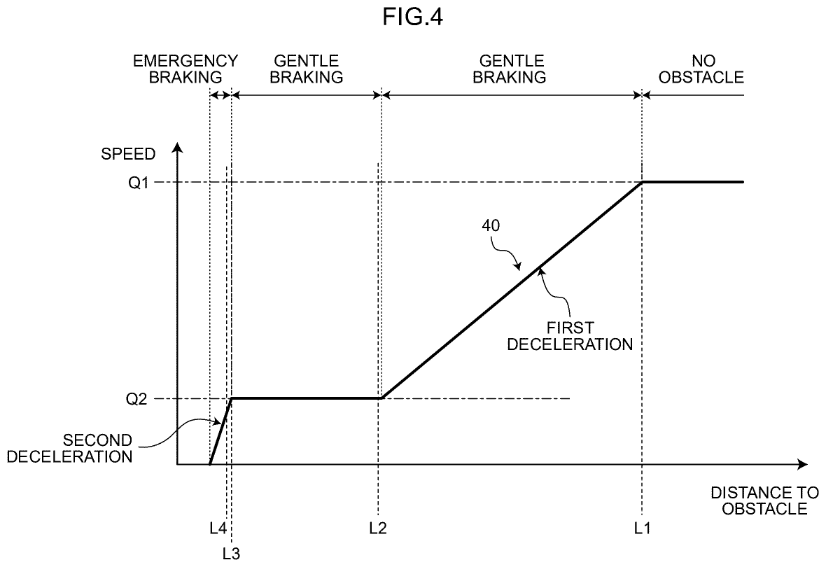

FIG. 4 is a graph 40 illustrating an example of a relationship between the distance to the obstacle 2 and the speed of the vehicle 1.

When the control unit 11 executes the deceleration control processing, the relationship between the distance from the vehicle 1 to the obstacle 2 in the traveling direction D of the vehicle 1 and the speed of the vehicle 1 is, for example, as illustrated in the graph 40. That is, it is assumed that the speed of the vehicle 1 when the distance between the vehicle 1 and the obstacle 2 is the first distance L1 or more is a speed Q1. In this case, as the control unit 11 executes the deceleration control processing, when the obstacle 2 is detected at a distance closer than the first distance L1, the vehicle 1 is subjected to deceleration control at the first deceleration. As the vehicle 1 is subjected to the deceleration control at the first deceleration, the vehicle 1 is decelerated from the speed Q1 to a speed Q2 which is the predetermined speed, for example. While the distance between the vehicle 1 and the obstacle 2 is a distance from the second distance L2 to the third distance L3, the vehicle 1 is controlled to travel at the speed Q2 which is the predetermined speed. When the obstacle 2 is detected at a distance closer than the fourth distance L4, the vehicle 1 is subjected to the deceleration control at the second deceleration.

Returning to FIG. 1, the description continues.

The control unit 11 according to the present embodiment also executes the display control processing on the display device 22 at the time of the deceleration control processing.

Specifically, as described above, in a case where the sensor device 14 detects the obstacle 2 at a distance closer than the first distance L1 in the traveling direction D of the vehicle 1 during the traveling of the vehicle 1 with the acceleration and deceleration operation and the steering operation of the passenger, the control unit 11 decelerates the vehicle 1 at the first deceleration.

The vehicle 1 is decelerated at the first deceleration, and the control unit 11 causes the display device 22 to display information representing that the vehicle 1 is being intentionally decelerated. That is, the control unit 11 causes the display device 22 to display the information representing that the vehicle 1 is being intentionally decelerated during the deceleration control processing of decelerating the vehicle 1 at the first deceleration.

Being intentionally decelerated means that the automated deceleration control is being performed without the operation related to the deceleration by the passenger.

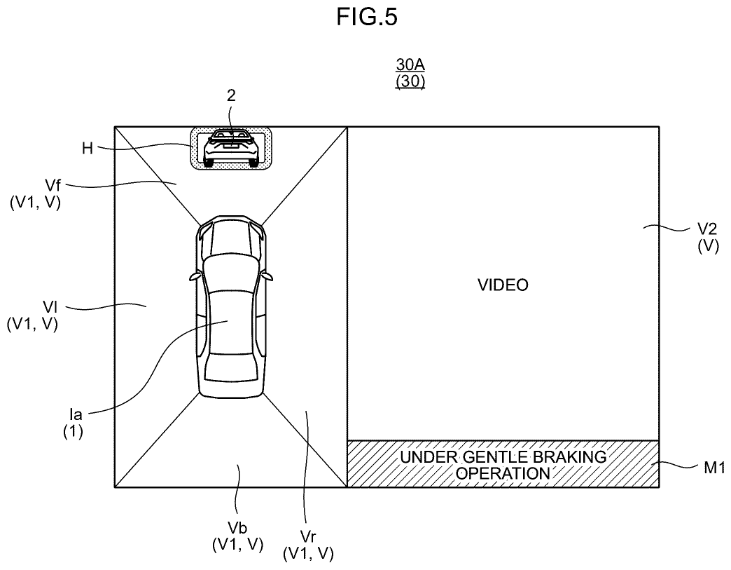

FIG. 5 is a schematic diagram of an example of a first screen 30A. The first screen 30A is an example of a screen 30 displayed on the display device 22.

The first screen 30A is an example of the screen 30 displayed on the display device 22 in a case where the sensor device 14 detects the obstacle 2 at a distance closer than the first distance L1 in the traveling direction D of the vehicle 1 during the traveling of the vehicle 1 with the acceleration and deceleration operation and the steering operation of the passenger.

The first screen 30A includes at least a first indicator M1, and the first indicator M1 is an indicator indicating that the vehicle 1 is being intentionally decelerated. FIG. 5 illustrates, as one example, a mode in which the first indicator M1 is a text indicating that the vehicle 1 is being intentionally decelerated. In addition, FIG. 5 illustrates a mode in which the text is “under gentle braking operation” as one example. The first indicator M1 may be a still image, an animation image, an icon, or the like indicating that the vehicle 1 is being intentionally decelerated, and is not limited to the text. By displaying the text indicating that the gentle braking is being operated, the control unit 11 can cause the display device 22 to display information representing that the automatic braking is being operated gently.

In addition, the first screen 30A may further include a video V captured by the camera 16. FIG. 5 illustrates a mode in which the first screen 30A includes a video V1 and a video V2 as the video V.

The video V1 is a video of a top view of the vehicle 1. The top view is a bird's-eye view image as if the vehicle 1 is viewed from above. It is sufficient that the control unit 11 generates and displays the video V1 by combining a video Vf, a video Vb, a video Vl, and a video Vr captured by the cameras 16 by a known method. The video Vf is the video V of the front side S3 of the vehicle 1 captured by the first camera 16A. The video Vb is the video V of the rear side S4 of the vehicle 1 captured by the fourth camera 16D. The video Vl is the video V of the second side S2 of the vehicle 1 captured by the third camera 16C. The video Vr is the video V of the first side S1 of the vehicle 1 captured by the second camera 16B.

The control unit 11 may arrange and display an image Ia schematically representing the vehicle 1 at a position corresponding to the current position of the vehicle 1 in the video V1. The control unit 11 may display the video V including the vehicle 1 on the display device 22. The control unit 11 may display the video V including the obstacle 2. The control unit 11 may apply a highlight H to the obstacle 2. It is sufficient that the highlight H is any display form that highlights the obstacle 2 included in the video V. FIG. 5 illustrates, as one example, a form in which the highlight H is a line image surrounding the obstacle 2 included in the video V. However, the highlight H may be any display form that highlights the obstacle 2 included in the video V, and is not limited to the line image. In a case where another image such as a map image is displayed on the display device 22, the control unit 11 may perform switching from another image and cause the display device 22 to display the first screen 30A including the first indicator M1, the obstacle 2, the highlight H, and the like.

Thereafter, as described above, the control unit 11 causes the vehicle 1 to travel at a predetermined speed from the second distance L2 to the third distance L3 as the distance from the vehicle 1 to the obstacle 2.

The control unit 11 executes the deceleration control processing of causing the vehicle 1 to travel at the predetermined speed from the second distance L2 to the third distance L3, and causes the display device 22 to display the information representing that the vehicle 1 is being intentionally decelerated. That is, the control unit 11 causes the display device 22 to display the information representing that the vehicle 1 is being intentionally decelerated during the deceleration control processing of causing the vehicle 1 to travel at the predetermined speed from the second distance L2 to the third distance L3 as the distance between the vehicle 1 and the obstacle 2.

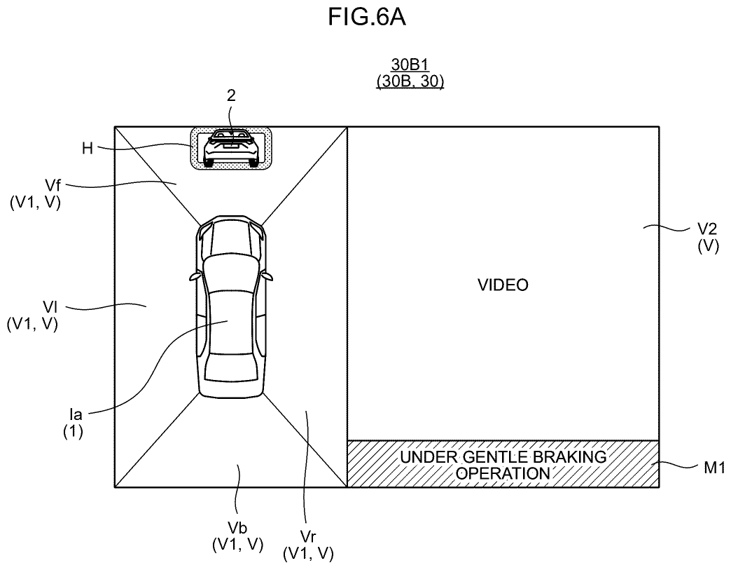

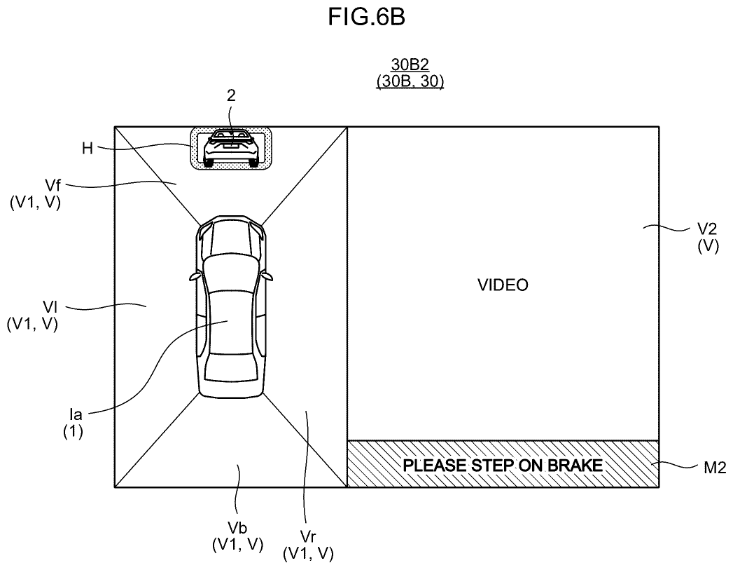

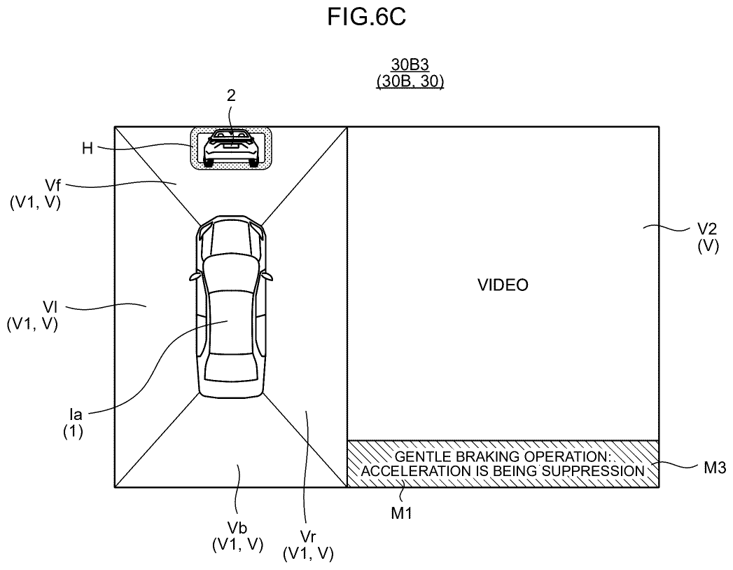

FIG. 6A is a schematic diagram of an example of a second screen 30B1.

The second screen 30B1 is an example of a second screen 30B. The second screen 30B is an example of the screen 30 displayed on the display device 22 when the vehicle 1 is caused to travel at the predetermined speed from the second distance L2 to the third distance L3 as the distance between the vehicle 1 and the obstacle 2.

The second screen 30B1 includes at least a first indicator M1. The first indicator M1 is an indicator indicating that the vehicle 1 is being intentionally decelerated, and is similar to the first indicator M1 described in the first screen 30A.

In addition, the second screen 30B1 may further include a video V captured by the camera 16. FIG. 6A illustrates a mode in which the second screen 30B1 includes a video V1 and a video V2 as the videos V.

The control unit 11 may arrange and display an image Ia schematically representing the vehicle 1 at a position corresponding to the current position of the vehicle 1 in the video V1. The control unit 11 may display the video V including the vehicle 1 on the display device 22. The control unit 11 may display the video V including the obstacle 2. The control unit 11 may apply a highlight H to the obstacle 2. The highlight H is similar to that described above.

When the control unit 11 causes the display device 22 to display the second screen 30B1 including the first indicator M1, the control unit 11 can cause the display device 22 to display the information representing that the automatic braking is being operated gently.

The control unit 11 may execute the deceleration control processing of causing the vehicle 1 to travel at the predetermined speed from the second distance L2 to the third distance L3, and cause the display device 22 to display the information representing that the vehicle 1 is being intentionally decelerated and information prompting the passenger to perform a deceleration operation.

The deceleration operation is, for example, an operation of the brake pedal included in the operation device 20 by the passenger.

FIG. 6B is a schematic diagram of an example of a second screen 30B2.

The second screen 30B2 is an example of the second screen 30B. The second screen 30B2 is similar to the second screen 30B1 except that a second indicator M2 is included instead of the first indicator M1.

The second indicator M2 is an indicator for prompting the passenger to perform the deceleration operation. FIG. 6B illustrates, as one example, a mode in which the second indicator M2 is a text prompting the passenger to perform the deceleration operation. FIG. 6B illustrates, as one example, a mode in which the text is “please step on the brake”. The second indicator M2 may be a still image, an animation image, an icon, or the like prompting the passenger to perform the deceleration operation, and is not limited to the text. By displaying the indicator prompting the passenger to perform the deceleration operation, the control unit 11 can prompt the passenger to perform the deceleration operation.

The control unit 11 may execute the deceleration control processing of causing the vehicle 1 to travel at the predetermined speed from the second distance L2 to the third distance L3, and cause the display device 22 to display the second indicator M2 prompting the passenger to perform the deceleration operation after causing the display device 22 to display the first indicator M1 indicating that the vehicle 1 is being intentionally decelerated. The control unit 11 may also execute the deceleration control processing of causing the vehicle 1 to travel at the predetermined speed from the second distance L2 to the third distance L3, and cause the display device 22 to display the first indicator M1 indicating that the vehicle is being intentionally decelerated after causing the display device 22 to display the second indicator M2 prompting the passenger to perform the deceleration operation. The control unit 11 may also execute the deceleration control processing of causing the vehicle 1 to travel at the predetermined speed from the second distance L2 to the third distance L3, and cause the display device 22 to simultaneously display both the first indicator M1 indicating that the vehicle is being intentionally decelerated and the second indicator M2 prompting the passenger to perform the deceleration operation.

The control unit 11 may also execute the deceleration control processing of causing the vehicle 1 to travel at the predetermined speed from the second distance L2 to the third distance L3, and receive an acceleration operation on the operation device 20 by the passenger in a suppressed manner.

Receiving the acceleration operation on the display device 22 by the passenger in a suppressed manner means that the control unit 11 receives an acceleration amount corresponding to an accelerator operation amount of the passenger as a smaller acceleration amount than that in a normal state. In this case, the control unit 11 may perform control not to receive an accelerator operation by the passenger. Therefore, by performing such control, the vehicle 1 is controlled such that the acceleration amount is not suppressed on an operation amount of the accelerator in the accelerator operation or the acceleration is not performed even in a case where the passenger performs the accelerator operation.

At this time, the control unit 11 may cause the display device 22 to display information representing that the reception of the acceleration operation by the passenger is being limited.

FIG. 6C is a schematic diagram of an example of a second screen 30B3.

The second screen 30B3 is an example of the second screen 30B.

The second screen 30B3 is similar to the second screen 30B1 except that a third indicator M3 is included together with the first indicator M1.

The third indicator M3 is an indicator indicating that the reception of the acceleration operation by the passenger is being limited. FIG. 6C illustrates, as one example, a mode in which the third indicator M3 is a text indicating that the reception of the acceleration operation by the passenger is being limited. FIG. 6C illustrates a mode in which the text is “acceleration is being suppressed” as one example. The third indicator M3 may be a still image, an animation image, an icon, or the like indicating that the reception of the acceleration operation by the passenger is being limited, and is not limited to the text. By displaying the indicator indicating that the reception of the acceleration operation by the passenger is being limited, the control unit 11 can provide, to the passenger, the information representing that the reception of the acceleration operation by the passenger is being limited.

The control unit 11 may execute the deceleration control processing of causing the vehicle 1 to travel at the predetermined speed from the second distance L2 to the third distance L3, and may cause the display device 22 to sequentially display the first indicator M1 indicating that the vehicle 1 is being intentionally decelerated, the second indicator M2 prompting the passenger to perform the deceleration operation, and the third indicator M3 indicating that the reception of the acceleration operation by the passenger is being limited. A display order of the first indicator M1, the second indicator M2, and the third indicator M3 is not limited.

Thereafter, as described above, in a case where the sensor device 14 detects the obstacle 2 at a distance closer than the fourth distance L4 in the traveling direction D of the vehicle 1, the control unit 11 decelerates the vehicle 1 at the second deceleration.

Thereafter, in a case where the sensor device 14 does not detect the obstacle 2 at a distance closer than the first distance L1 from the vehicle 1 in the traveling direction D of the vehicle 1, the control unit 11 causes the display device 22 to stop displaying the information representing that the vehicle 1 is being intentionally decelerated, stops the reception of the acceleration operation by the passenger on the operation device 20 in a suppressed manner, and causes the display device 22 to stop displaying the information representing that the reception of the acceleration operation by the passenger is being limited.

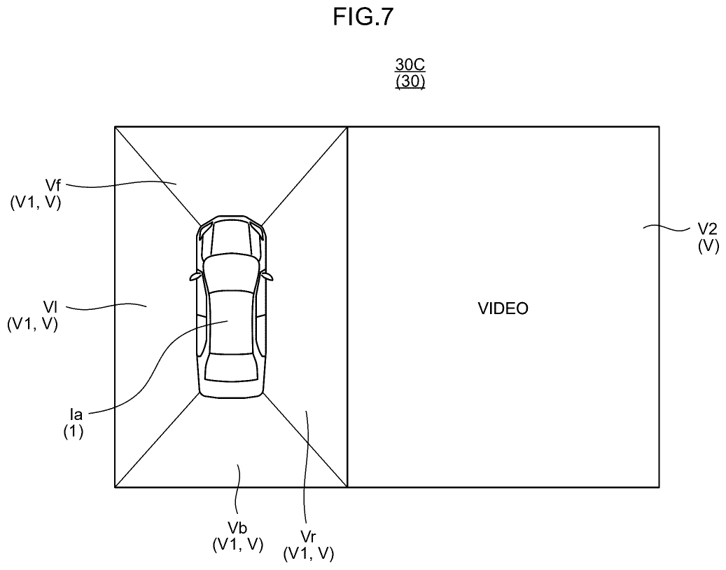

FIG. 7 is a schematic diagram of an example of a third screen 30C. The third screen 30C is an example of the screen 30 displayed on the display device 22 in a case where the obstacle 2 is not detected at a distance closer than the first distance L1 from the vehicle 1 in the traveling direction D of the vehicle 1.

The third screen 30C is similar to the first screen 30A except that the first indicator M1, the obstacle 2, and the highlight H are not included. That is, in a case where the sensor device 14 does not detect the obstacle 2 at a distance closer than the first distance L1 from the vehicle 1 in the traveling direction D of the vehicle 1, the control unit 11 controls the display device 22 to stop displaying the first indicator M1, the second indicator M2, and the third indicator M3. The control unit 11 controls the display device 22 to stop displaying the highlight H. In addition, the control unit 11 stops receiving the acceleration operation by the passenger in a suppressed manner. Therefore, an alarm indicator such as the first indicator M1, the second indicator M2, the third indicator M3, and the highlight H displayed on the screen 30 is deactivated. In addition, the reception of the acceleration operation by the passenger in a suppressed manner is canceled.

Next, an example of a procedure of information processing executed by the vehicle control device 10 according to the present embodiment will be described.

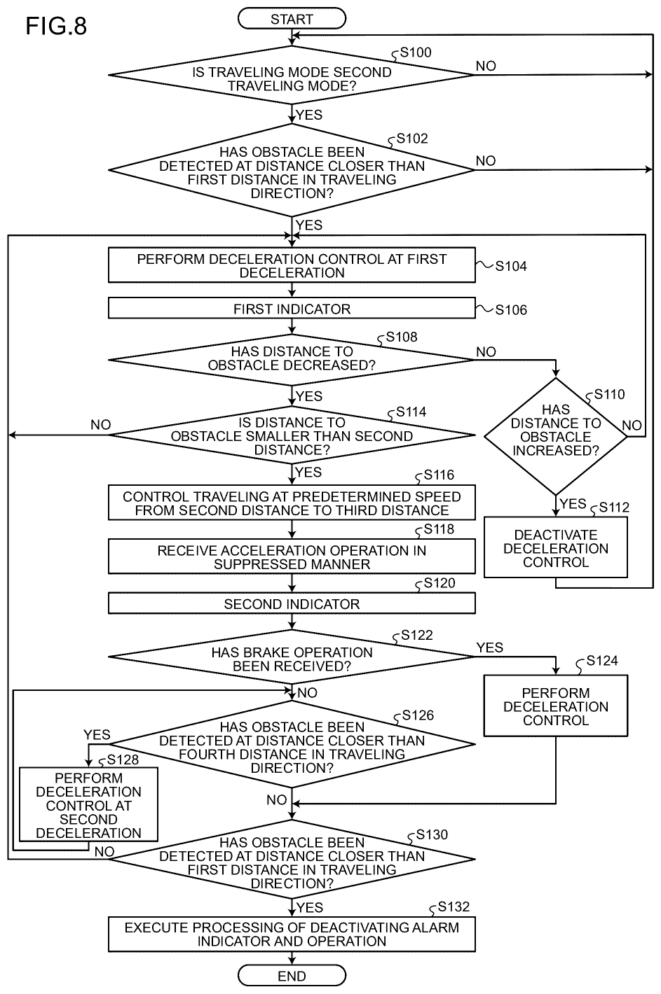

FIG. 8 is a flowchart illustrating an example of the procedure of the information processing executed by the control unit 11.

The control unit 11 determines whether or not the traveling mode of the vehicle 1 is the second traveling mode (step S100). The control unit 11 repeats a negative determination (step S100: No) until an affirmative determination is made in step S100 (step S100: Yes). When an affirmative determination is made in step S100 (step S100: Yes), the control unit 11 proceeds to step S102.

In step S102, the control unit 11 determines whether or not the sensor device 14 has detected the obstacle 2 at a distance closer than the first distance L1 in the traveling direction D of the vehicle 1 during the traveling of the vehicle 1 with the acceleration and deceleration operation and the steering operation of the passenger (step S102). When a negative determination is made in step S102 (step S102: No), the processing returns to step S100. When an affirmative determination is made in step S102 (step S102: Yes), the processing proceeds to step S104.

In step S104, the control unit 11 controls the movement control device 12 to perform the deceleration at the first deceleration (step S104). In addition, the control unit 11 causes the display device 22 to display the screen 30 including an indicator (the first indicator M1) indicating that the vehicle is being intentionally decelerated (step S106). By the processing of step S106, for example, the first screen 30A illustrated in FIG. 5 is displayed on the display device 22.

Next, the control unit 11 determines whether or not the distance between the obstacle 2 detected in step S102 and the vehicle 1 has decreased (step S108). When a negative determination is made in step S108 (step S108: No), the processing proceeds to step S110. In step S110, the control unit 11 determines whether or not the distance between the obstacle 2 detected in step S102 and the vehicle 1 has increased (step S110). When a negative determination is made in step S110 (step S100: No), the processing returns to step S104. When an affirmative determination is made in step S110 (step S110: Yes), the processing proceeds to step S112. In step S112, the control unit 11 deactivates the deceleration control at the first deceleration performed in step S104 (step S112), and returns to step S100.

On the other hand, when an affirmative determination is made in step S108 (step S108: Yes), the processing proceeds to step S114. In step S114, the control unit 11 determines whether or not the distance between the obstacle 2 detected in step S102 and the vehicle 1 is smaller than the second distance L2 (step S114). When a negative determination is made in step S114 (step S114: No), the processing returns to step S104. When an affirmative determination is made in step S114 (step S114: Yes), the processing proceeds to step S116.

In step S116, the control unit 11 causes the vehicle 1 to travel at the predetermined speed from the second distance L2 to the third distance L3 as the distance between the vehicle 1 and the obstacle 2 (step S116). The control unit 11 receives the acceleration operation by the passenger on the operation device 20 in a suppressed manner (step S118). In addition, the control unit 11 causes the display device 22 to simultaneously or sequentially display the first indicator M1 indicating that the vehicle is being intentionally decelerated, the second indicator M2 prompting the passenger to perform the deceleration operation, and the third indicator M3 indicating that the reception of the acceleration operation by the passenger is being limited (step S120). By the processing of step S120, the second screen 30B1, the second screen 30B2, and the second screen 30B3 illustrated in FIGS. 6A to 6C are displayed on the display device 22.

Next, the control unit 11 determines whether or not a brake operation by the passenger has been received (step S122). When an affirmative determination is made in step S122 (step S122: Yes), the processing proceeds to step S124. In step S124, the control unit 11 controls the movement control device 12 to perform the deceleration in accordance with the operation of the brake included in the operation device 20 by the passenger (step S124). Then, the processing proceeds to step S130 described below.

When a negative determination is made in step S122 (step S122: No), the processing proceeds to step S126. In step S126, the control unit 11 determines whether or not the obstacle 2 has been detected at a distance closer than the fourth distance L4 in the traveling direction D of the vehicle 1 (step S126). When an affirmative determination is made in step S126 (step S126: Yes), the processing proceeds to step S128. In step S128, the control unit 11 controls the movement control device 12 to perform the deceleration at the second deceleration (step S128). Then, the processing proceeds to step S126.

When a negative determination is made in step S126 (step S126: No), the processing proceeds to step S130. In step S130, the control unit 11 determines whether or not the obstacle 2 has been detected at a distance closer than the first distance L1 in the traveling direction D of the vehicle 1 (step S130). When an affirmative determination is made in step S130 (step S130: Yes), the processing proceeds to step S104. When a negative determination is made in step S130 (step S130: No), the processing proceeds to step S132.

In step S132, the control unit 11 executes processing of deactivating the alarm indicator and the operation (step S132). In step S132, the control unit 11 causes the display device 22 to stop displaying the information representing that the vehicle is being intentionally decelerated, stops the reception of the acceleration operation by the passenger on the operation device 20 in a suppressed manner, and causes the display device 22 to stop displaying the information representing that the reception of the acceleration operation by the passenger is being limited. Then, this routine ends.

As described above, the vehicle control device 10 according to the present embodiment is provided in the vehicle 1. The vehicle 1 includes the operation device 20 that receives the operation of the passenger, the sensor device 14 that acquires the outside situation, the display device 22 that is visually recognizable by the passenger, and the movement control device 12 that controls at least the deceleration. In the vehicle control method executed by the vehicle control device 10, in a case where the sensor device 14 detects the obstacle 2 at a distance closer than the first distance L1 from the vehicle 1 in the traveling direction D of the vehicle 1 during the traveling of the vehicle 1 with the acceleration and deceleration operation and the steering operation of the passenger, the vehicle 1 is decelerated at the first deceleration. Thereafter, in the vehicle control method, the vehicle 1 is caused to travel at the predetermined speed from the second distance L2 shorter than the first distance L1 to the third distance L3 shorter than the second distance L2 as the distance from the vehicle 1 to the obstacle 2, and the display device 22 is caused to display the information representing that the vehicle 1 is being intentionally decelerated. Thereafter, in the vehicle control method, in a case where the sensor device 14 detects the obstacle 2 at a distance closer than the fourth distance L4 shorter than the third distance L3 from the vehicle 1 in the traveling direction D of the vehicle 1, the vehicle 1 is decelerated at the second deceleration greater than the first deceleration.

As described above, in the vehicle control method according to the present embodiment, in a case where the obstacle 2 is detected at a distance closer than the first distance L1 in the traveling direction D of the vehicle 1, the vehicle 1 is decelerated at the first deceleration. Then, in the vehicle control method, the vehicle 1 is caused to travel at the predetermined speed from the second distance L2 to the third distance L3 as the distance between the vehicle 1 and the obstacle 2, and the display device 22 is caused to display the information representing that the vehicle 1 is being intentionally decelerated. Thereafter, in the vehicle control method, in a case where the distance between the vehicle 1 and the obstacle 2 is shorter than the fourth distance L4, the vehicle 1 is decelerated at the second deceleration greater than the first deceleration.

Therefore, in the vehicle control method according to the present embodiment, the display device 22 can be caused to display the information representing that the vehicle is being intentionally decelerated when the automated deceleration is performed at the first deceleration for collision avoidance.

Therefore, the vehicle control method according to the present embodiment can assist more suitable traveling.

Next, a hardware configuration of the vehicle control device 10 according to the present embodiment will be described.

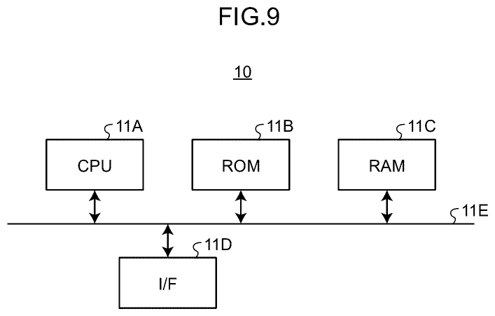

FIG. 9 is a block diagram illustrating a hardware configuration example of the vehicle control device 10.

The vehicle control device 10 has a hardware configuration of a normal computer in which a central processing unit (CPU) 11A, a read only memory (ROM) 11B, a random access memory (RAM) 11C, an interface (I/F) 11D for connecting to various devices, and the like are connected to one another by a bus 11E.

The CPU 11A (an example of a hardware processor) is an arithmetic device that controls the entire processing of the vehicle control device 10. The RAM 11C stores data necessary for various types of processing executed by the CPU 11A. The ROM 11B stores a computer program for implementing various types of processing executed by the CPU 11A. The I/F 11D is an interface that is connected to an external device or an external terminal via a communication line or the like and transmits and receives data to and from the connected external device or external terminal.

A computer program for executing the above-described various types of processing executed by the vehicle control device 10 is provided by being incorporated in the ROM 11B or the like in advance. A computer program for executing the vehicle control method executed in the present embodiment may be provided by being recorded in a computer-readable recording medium such as a CD-ROM, a flexible disk (FD), a CD-R, or a digital versatile disc (DVD) as a file in a format installable or executable in these devices.

The computer program for executing the vehicle control method executed in the present embodiment may be stored on a computer connected to a network such as the Internet and provided by being downloaded via the network. The computer program for executing the vehicle control method executed in the present embodiment may be provided or distributed via a network such as the Internet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method executed by a vehicle control device provided in a vehicle, the vehicle including an operation device to receive an operation of a passenger, a sensor device to detect an outside situation, a display device to display information visually recognizable by the passenger, and a movement control device to control at least deceleration of the vehicle, the vehicle control method comprising:
decelerating the vehicle at a first deceleration, in a case where the sensor device detects an obstacle at a distance closer than a first distance from the vehicle in a traveling direction of the vehicle during traveling of the vehicle with an acceleration and deceleration operation and a steering operation by the passenger;
causing the vehicle to travel at a predetermined speed from a second distance shorter than the first distance to a third distance shorter than the second distance within a distance from the vehicle to the obstacle, and causing the display device to display information representing that the vehicle is being intentionally decelerated; and
decelerating the vehicle at a second deceleration greater than the first deceleration, in a case where the sensor device detects the obstacle at a distance closer than a fourth distance shorter than the third distance from the vehicle in the traveling direction of the vehicle.

2. The vehicle control method according to claim 1, further comprising:
decelerating the vehicle at the first deceleration and causing the display device to display the information representing that the vehicle is being intentionally decelerated, in a case where the sensor device detects the obstacle at a distance closer than the first distance from the vehicle in the traveling direction of the vehicle during the traveling of the vehicle with the acceleration and deceleration operation and the steering operation by the passenger;
causing the vehicle to travel at the predetermined speed from the second distance to the third distance within the distance from the vehicle to the obstacle, and causing the display device to display the information representing that the vehicle is being intentionally decelerated; and
decelerating the vehicle at the second deceleration, in a case where the sensor device detects the obstacle at a distance closer than the fourth distance from the vehicle in the traveling direction of the vehicle.

3. The vehicle control method according to claim 1, wherein
the movement control device of the vehicle controls acceleration and deceleration and steering,
the vehicle operates in a first traveling mode in which the vehicle autonomously travels by autonomously controlling at least the acceleration and deceleration and the steering, or in a second traveling mode in which the deceleration is autonomously controlled without autonomously controlling at least the steering and the acceleration, and
the vehicle control method further comprises:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation by the passenger in the second traveling mode,
causing the vehicle to travel at the predetermined speed from the second distance to the third distance within the distance from the vehicle to the obstacle, and causing the display device to display the information representing that the vehicle is being intentionally decelerated; and
decelerating the vehicle at the second deceleration, in a case where the sensor device detects the obstacle at a distance closer than the fourth distance from the vehicle in the traveling direction of the vehicle.

4. The vehicle control method according to claim 1, wherein
the sensor device includes a camera to capture at least part of surroundings of the vehicle as a video, and
the display device displays the video including the obstacle.

5. The vehicle control method according to claim 4, wherein the obstacle captured in the video displayed by the display device is highlighted.

6. The vehicle control method according to claim 4, further comprising:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, and causing the display device to display the video including the obstacle; and
decelerating the vehicle at the second deceleration, in a case where the sensor device detects the obstacle at a distance closer than the fourth distance from the vehicle in the traveling direction of the vehicle.

7. The vehicle control method according to claim 1, further comprising:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, and causing the display device to display information prompting the passenger to perform a deceleration operation; and
decelerating the vehicle at the second deceleration, in a case where the sensor device detects the obstacle at a distance closer than the fourth distance from the vehicle in the traveling direction of the vehicle.

8. The vehicle control method according to claim 1, further comprising:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, and receiving, in a suppressed manner, an acceleration operation by the passenger on the operation device; and
decelerating the vehicle at the second deceleration, in a case where the sensor device detects the obstacle at a distance closer than the fourth distance from the vehicle in the traveling direction of the vehicle.

9. The vehicle control method according to claim 8, further comprising:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, receiving, in a suppressed manner, an acceleration operation by the passenger on the operation device, and causing the display device to display information representing that the reception of the acceleration operation by the passenger is being limited; and
decelerating the vehicle at the second deceleration, in a case where the sensor device detects the obstacle at a distance closer than the fourth distance from the vehicle in the traveling direction of the vehicle.

10. The vehicle control method according to claim 9, further comprising:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, receiving, in a suppressed manner, an acceleration operation by the passenger on the operation device, and causing the display device to display information representing that the reception of the acceleration operation by the passenger is being limited; and,
in a case where the sensor device does not detect the obstacle at a distance closer than the first distance from the vehicle in the traveling direction of the vehicle,
causing the display device to stop displaying the information representing that the vehicle is being intentionally decelerated,
stopping the reception in a suppressed manner of the acceleration operation by the passenger on the operation device, and
causing the display device to stop displaying the information representing that the reception of the acceleration operation by the passenger is being limited.

11. A vehicle control device provided in a vehicle, the vehicle including an operation device to receive an operation of a passenger, a sensor device to detect an outside situation, a display device to display information visually recognizable by the passenger, and a movement control device to control at least deceleration of the vehicle, the vehicle control device comprising:
a hardware processor connected to a memory and configured to perform processing, the processing including:
decelerating the vehicle at a first deceleration, in a case where the sensor device detects an obstacle at a distance closer than a first distance from the vehicle in a traveling direction of the vehicle during traveling of the vehicle with an acceleration and deceleration operation and a steering operation by the passenger;
causing the vehicle to travel at a predetermined speed from a second distance shorter than the first distance to a third distance shorter than the second distance within a distance from the vehicle to the obstacle, and causing the display device to display information representing that the vehicle is being intentionally decelerated; and
decelerating the vehicle at a second deceleration greater than the first deceleration, in a case where the sensor device detects the obstacle at a distance closer than a fourth distance shorter than the third distance from the vehicle in the traveling direction of the vehicle.

12. The vehicle control device according to claim 11, wherein the processing performed by the hardware processor further includes:
decelerating the vehicle at the first deceleration and causing the display device to display the information representing that the vehicle is being intentionally decelerated, in a case where the sensor device detects the obstacle at a distance closer than the first distance from the vehicle in the traveling direction of the vehicle during the traveling of the vehicle with the acceleration and deceleration operation and the steering operation by the passenger;
causing the vehicle to travel at the predetermined speed from the second distance to the third distance within the distance from the vehicle to the obstacle, and causing the display device to display the information representing that the vehicle is being intentionally decelerated; and
decelerating the vehicle at the second deceleration, in a case where the sensor device detects the obstacle at a distance closer than the fourth distance from the vehicle in the traveling direction of the vehicle.

13. The vehicle control device according to claim 11, wherein
the movement control device of the vehicle controls acceleration and deceleration and steering,
the vehicle operates in a first traveling mode in which the vehicle autonomously travels by autonomously controlling at least the acceleration and deceleration and the steering, or in a second traveling mode in which the deceleration is autonomously controlled without autonomously controlling at least the steering and the acceleration, and
the processing performed by the hardware processor further includes:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation by the passenger in the second traveling mode,
causing the vehicle to travel at the predetermined speed from the second distance to the third distance within the distance from the vehicle to the obstacle, and causing the display device to display the information representing that the vehicle is being intentionally decelerated; and
decelerating the vehicle at the second deceleration, in a case where the sensor device detects the obstacle at a distance closer than the fourth distance from the vehicle in the traveling direction of the vehicle.

14. The vehicle control device according to claim 11, wherein
the sensor device includes a camera to capture at least part of surroundings of the vehicle as a video, and
the display device displays the video including the obstacle.

15. The vehicle control device according to claim 14, wherein the obstacle captured in the video displayed by the display device is highlighted.

16. The vehicle control device according to claim 14, wherein the processing performed by the hardware processor further includes:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, and causing the display device to display the video including the obstacle; and
decelerating the vehicle at the second deceleration, in a case where the sensor device detects the obstacle at a distance closer than the fourth distance from the vehicle in the traveling direction of the vehicle.

17. The vehicle control device according to claim 11, wherein the processing performed by the hardware processor further includes:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, and causing the display device to display information prompting the passenger to perform a deceleration operation; and
decelerating the vehicle at the second deceleration, in a case where the sensor device detects the obstacle at a distance closer than the fourth distance from the vehicle in the traveling direction of the vehicle.

18. The vehicle control device according to claim 11, wherein the processing performed by the hardware processor further includes:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, and receiving, in a suppressed manner, an acceleration operation by the passenger on the operation device; and
decelerating the vehicle at the second deceleration, in a case where the sensor device detects the obstacle at a distance closer than the fourth distance from the vehicle in the traveling direction of the vehicle.

19. The vehicle control device according to claim 18, wherein the processing performed by the hardware processor further includes:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, receiving, in a suppressed manner, an acceleration operation by the passenger on the operation device, and causing the display device to display information representing that the reception of the acceleration operation by the passenger is being limited; and
decelerating the vehicle at the second deceleration, in a case where the sensor device detects the obstacle at a distance closer than the fourth distance from the vehicle in the traveling direction of the vehicle.

20. The vehicle control device according to claim 19, wherein the processing performed by the hardware processor further includes:
decelerating the vehicle at the first deceleration, in a case where the sensor device detects the obstacle at a distance closer than the first distance from the vehicle in the traveling direction of the vehicle during the traveling of the vehicle with the acceleration and deceleration operation and the steering operation of the passenger;
causing the vehicle to travel at the predetermined speed from the second distance to the third distance within the distance from the vehicle to the obstacle, causing the display device to display the information representing that the vehicle is being intentionally decelerated, receiving, in a suppressed manner, an acceleration operation by the passenger on the operation device, and causing the display device to display information representing that the reception of the acceleration operation by the passenger is being limited; and,
in a case where the sensor device does not detect the obstacle at a distance closer than the first distance from the vehicle in the traveling direction of the vehicle,
causing the display device to stop displaying the information representing that the vehicle is being intentionally decelerated,
stopping the reception in a suppressed manner of the acceleration operation by the passenger on the operation device, and
causing the display device to stop displaying the information representing that the reception of the acceleration operation by the passenger is being limited.
